(19) United States
(12) Patent Application Publication
(10) Pub. No.: US 2005/0043478 A1
(43) Pub. Date: Feb. 24, 2005

(54) Nano fluorine water-and oil-repellent and process for producing the same

(75) Inventors: Pei Yuan Huang, Taipei City (TW); Ren Ren Chiou, Taipei City (TW)

Correspondence Address: BACON & THOMAS, PLLC, 625 SLATERS LANE, FOURTH FLOOR, ALEXANDRIA, VA, 22314, US

(73) Assignee: JINTEX CORPORATION LTD., Taipei City (TW)

(21) Appl. No.: 10/703,458

(22) Filed: Nov. 10, 2003

(30) Foreign Application Priority Data
Aug. 21, 2003 (TW) 92122987

(51) Int. Cl. C08K 3/00

(52) U.S. Cl. 524/805

(57) ABSTRACT

This invention discloses a nano fluorinated water- and oil-water- and oil-repellent and process for producing the same. The nano fluorinated water- and oil-repellent, water- and oil-existing in the form of aqueous dispersant with particle size averaging less than 100 nm, water- and oil- has superior stability and could be applied in the treatment of various fiber products, leather and paper products.

### BACKGROUND OF THE INVENTION

1. Field of the Invention

The present invention relates to a nano fluorinated water- and oil-repellent and process for producing the same, exhibiting excellent applicability to all kinds of fiber products, leather products and paper products.

2. Description of the Related Art

Practically all fluorinated water- and oil-repellents exist in the form of solvent or aqueous dispersant, wherein solvent-type fluorinated water- and oil-repellents tend to cause pollution to the environment and pose a fire hazard, thus gradually replaced by water dispersant-type fluorinated water- and oil-repellent systems in recent years. The producing of water dispersant type fluorinated water- and oil-repellent requires the addition of surfactant and proper auxiliary surfactants that the dispersion of fluoropolymers in the water could be stabilized. But the emulsion particles of fluorinated water- and oil-repellent products currently available, due to technological limitation, all exist with average sizes over 0.1˜0.3 μm and unevenly size distribution. As a result, the emulsions tend to be unstable, change over time, and have limited applications. Oftentimes, fluorinated water- and oil-repellents are custom-made for fiber products, such as polyester, nylon, and cotton, and leather products that could not be applied extensively.

### SUMMARY OF THE INVENTION

To address the drawbacks of prior art, the present invention provides a nano fluorinated water- and oil-repellent in the form of aqueous dispersant, mainly comprising fluorinated acrylic and other acrylic monomers, characterized in which the average particle size of the emulsions is less than 100 nm.

Another objective of the present invention is to provide a fluorinated water- and oil-repellent, comprising 5-35 wt % fluorinated acrylic and other acrylic monomers; 0.2˜3 wt % surfactant, preferably 0.5˜1.5 wt %; 0.05˜1.5 wt % auxiliary surfactant, preferably 0.2˜0.8 wt %; 60˜90 wt % deionized water, preferably 65˜80 wt %; 0.05˜0.5 wt % chain transfer agent, preferably 0.08˜0.2 wt %; 0.5˜15 wt % solubilizing agent, preferably 1˜5 wt %; 0.05˜0.5 wt % initiator, preferably 0.08˜0.2 wt %; and 0.02˜0.1 wt % buffering agent, preferably 0.04˜0.08 wt %; wherein said nano fluorinated water- and oil-repellent is characterized in that the average particle size of the emulsion is less than 100 nm.

The aforesaid fluorinated acrylic and other acrylic monomers comprise: 1.5˜15 wt % perfluoroalkylethyl (meth)acrylate monomer or perfluoropolyether ethyl acrylate monomer, preferably 5˜12 wt %; 1.5˜15 wt % nonfluorinated (meth)acrylate, preferably 5˜12 wt %; 0.5˜5 wt % other special monomers, preferably 0.8˜3 wt %. The aforesaid perfluoroalkyl ethyl(meth)acrylate monomer or perfluoropolyether ethyl acrylate monomer has the following structures: 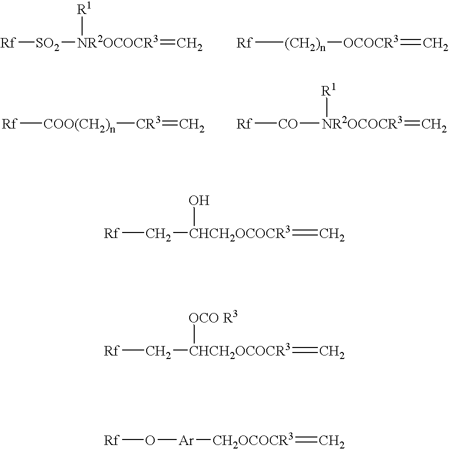
Wherein Rf is C₃₋₂₁ polyfluoroalkyl, polyfluoro alkyl or perfluoropolyether having average molecular weight of 500˜5000, R¹ is hydrogen or C₁₋₁₀ alkyl, R² is C₁₋₁₀ alkylene, R³ is hydrogen or methyl, Ar is substituent-containing phenyl, and n is an integer from 1 to 10.

The aforesaid non-fluorinated (meth)acrylate comprises preferably alkyl (meth)acrylate containing C₂₋₂₂ straight or branched alkyl, and more preferably alkyl (meth) acrylate containing C₆₋₁₈ straight or branched alkyl.

The aforesaid other special monomers comprise N-methylol monomer, hydroxyalkyl (meth)acrylate monomer, alkoxy(meth)acrylate monomer, vinyl chloride, vinyl halide, styrene, glycidyl methacrylate, or 3-chloro-2-hydroxy-propyl methacrylate.

The aforesaid N-methylol monomer can be N-methylol-acrylamide or N-methylol-methacrylamide.

The aforesaid hydroxyalkyl (meth)acrylate monomer is that containing C₂₋₄ alkyl chain such as, but not limited to, 2-hydroxyethyl acrylate or 2-hydroxyethyl methacrylate (2-HEMA).

The aforesaid alkoxy(meth)acrylate monomer is that containing C₂₋₄ alkyl chain, preferably containing between 1 to 12 oxyalkylene units per molecule; and more preferably with each molecule having 4 to 10 oxyalkylene units. The aforesaid surfactant comprises cationic surfactant or nonionic surfactant, wherein said cationic surfactant comprises amine salt, quaternary ammonium salt, or oxyethylene-containing ammonium hydrochloride salt; the nonionic surfactant comprises: alkylphenylpolyoxyethylene, alkylpolyoxyethylene, alkylpolyoxyalkylene polyoxyethylene, fatty acid ester, alkylaminepolyoxyethylene, alkylamidepolyoxyethylene, alkylaminepoly(oxyethyleneoxypropylene), or alkylamineoxide.

The aforesaid auxiliary surfactant comprises hydrophoic substances, low molecular weight polymer, alkyl alcohol, alkyl mercaptan, comonomers or oil soluble initiator.

The aforesaid solubilizing agent includes methanol, isopropanol, ethyl acetate, butyl acetate, acetone, butanone, ethylene glycol, hexylene glycol, propylene glycol, dipropyleneglycol monobutylether, hexylene glycol or dipropylene gylcol.

The aforesaid initiator comprises ammonium persulfate, sodium persulfate, 2,2′azobis-(2-amidinopropane)dihydrochloride, azobisisobutylnitrile (AIBN), or benzoyl peroxide.

The aforesaid buffering agent comprises acetic acid, phosphoric acid, malic acid, citric acid, and the sodium salt or potassium salt of said substances.

Another objective of the present invention is to provide a process for producing fluorinated water- and oil-repellent, comprising the steps of:
(a). mixing the components well;
(b). homogenizing the mixture obtained in said step (a). through a homogenizer under working pressure of 100˜500 bar at least twice to obtain a pre-emulsion mixture; and
(c). subjecting the pre-emulsion mixture obtained in said step (b). to emulsion polymerization under reaction temperature of 40˜90° C. and reaction time of 4˜24 hours.

The polymerization reaction used in the aforesaid process comprises microemulsion polymerization or miniemulsion polymerization, and the reaction maybe carried out by means of batch polymerization, semi-continuous polymerization or core-shell polymerization.

If necessary, the aforesaid step (b). could further comprise a heating procedure (about 30˜50° C.) to mix the components evenly.

The nano fluorinated water- and oil-repellent of the present invention exists in the form of aqueous dispersant having average particle size of less than 100 nm. It has excellent stability and may be applied in the treatment of all kinds of fiber products, leather products, and paper products.

### DETAILED DESCRIPTION OF THE INVENTION

The nano fluorinated water- and oil-repellent of the present invention existing in the form of aqueous dispersant, wherein the particle size of the finished emulsions product having an average of less than 100 nm, is a nanoemulsion and suitable for all kinds of fiber products, leather products, and paper products. The stability of the nanoemulsions is more stable than those products currently available. Moreover, the water- and oil-repellent of the present invention exhibits excellent penetration to enhance the effect of water and oil repellency, lower the curing temperature and improve the discoloration. In the example of fiber products, the water- and oil-repellent of the present invention may be applied to the surface of fiber product by means of padding, spraying or coating. If necessary, a heat curing step may be added to the process, for example, treating the textile under 100° C.˜190° C. for at least 60 seconds, typically 60 to 200 seconds, to render the product with excellent water and oil repellency.

The nano fluorinated water- and oil-repellent of the present invention comprises of the following components: fluorinated acrylic and other acrylic monomers; surfactant; auxiliary surfactant; water; chain transfer agent; solubilizing agent; initiator and buffering agent.

The fluorinated acrylic and other acrylic monomers are copolymerized from the following monomers: perfluoroalkylethyl (meth)acrylate monomer or perfluoropolyetherethyl acrylate monomer having the following structure: 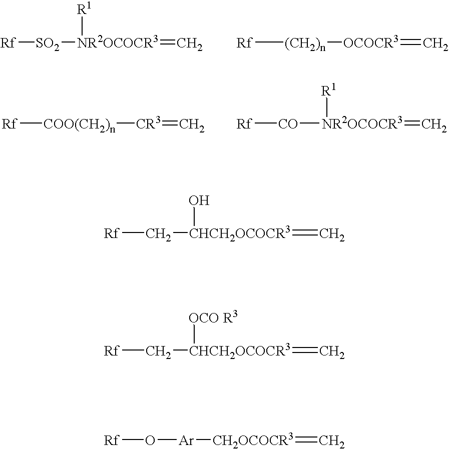
Wherein Rf is C₃₋₂₁ polyfluoroalkyl, polyfluoro alkyl or perfluoropolyether having average molecular weight of 500˜5000, R¹ is hydrogen or C₁₋₁₀ alkyl, R² is C₁₋₁₀ alkylene, R³ is hydrogen or methyl, Ar is substituent-containing phenyl, and n is an integer from 1 to 10.

The aforesaid perfluoropolyether may have the structure of:
F(CF(CF₃)CF₂O)ₙCF₂CF₂— wherein n is an integer from 3 to 30.
CF₃O(CF(CF₃)CF₂O)ₙ(CF₂O)ₘCF₂— wherein n is an integer from 3 to 30 and m is an integer from 3 to 70.
CF₃O(CF₂CF₂O)ₙ(CF₂O)ₘCF₂— wherein n is an integer from 2 to 40 and m is an integer from 4 to 70.
F(CFCF₂CF₂O)ₙCF₂CF₂— wherein n is an integer from 3 to 30.

The functional group after the symbol “−” is (meth)acrylate.

The examples of the aforesaid perfluoropolyether are:
CF₃(CF₂)₇(CH₂)OCOCH═CH₂
CF₃(CF₂)₆(CH₂)OCOC(CH₃)═CH₂
(CF₃)₂CF(CF₂)₆(CH₂)₂OCOCH═CH₂
CF₃(CF₂)₇(CH₂)₂OCOCH═CH₂
CF₃(CF₂)₇(CH₂)₂OCOC(CH₃)═CH₂
CF₃(CF₂)₇SO₂N(CH₃)(CH₂)₂OCOCH═CH₂
CF₃(CF₂)₇SO₂N(CH₃)(CH₂)₂OCOC(CH₃)═CH₂
(CF₃)₂CF(CF₂)₆CH₂CH(OCOCH₃)CH₂OCOCH═CH₂
(CF₃)₂CF(CF₂)₆CH₂CH(OCOCH₃)CH₂OCOC(CH₃)═CH₂
(CF₃)₂CF(CF₂)₆CH₂CH(OH)CH₂OCOCH═CH₂
(CF₃)₂CF(CF₂)₆CH₂CH(OH)CH₂OCOC(CH₃)═CH₂
C₈F₁₇—O—Ar—CH₂O—COCH═CH₂
C₈F₁₇—O—Ar—CH₂O—COC(CH₃)—CH₂
C₆F₁₃—O—Ar—CH₂O—COCH═CH₂
C₆F₁₃—O—Ar—CH₂O—COC(CH₃)═CH₂
(CF(CF₂)CF₂O)₁₀ CF₂ CF₂—OCOCH₂CH₂CH═CH₂

The aforesaid non-fluorinated (meth)acrylate comprises alkyl (meth)acrylate having C₂₋₂₂ straight or branched alkyl, preferably C₆₋₁₈ straight or branched alkyl. Examples of alkyl group (linear or branched) of said (meth)acrylate include: ethyl, propyl, butyl, isoamyl, hexyl, cyclohexyl, octyl, 2-ethylhexyl, decyl, isodecyl, dodecyl, benenyl or stearyl group. The preferred examples of said (meth)acrylate are cyclohexyl (meth)acrylate, dodecyl (meth)acrylate, and stearyl (meth)acrylate.

The aforesaid other special monomers comprise N-methylol monomers, such as N-methylolacrylamide or N-methylolacrylamine; hydroxyalkyl (meth)acrylate monomer having C₂₋₄ alkyl chain, such as 2-hydroxyethyl acrylate or 2-hydroxyethyl methacrylate (2-HEMA); alkoxy(meth)acrylate monomer having C₂₋₄ alkyl chain with each molecule having 1 to 12 oxyalkylene units, preferably with each molecule having 4 to 10 oxyalkylene units; vinyl chloride or vinyl halide; styrene; glycidyl methacrylate, or 3-chloro-2-hydroxy-propyl methacrylate.

The aforesaid surfactant comprises cationic surfactant or nonionic surfactant, could be used alone or by mixing two different types of surfactant. The cationic surfactant used mainly comprises amine salt, quaternary ammonium salt, and oxyethylene-addition type ammonium hydrochloride. The preferred examples are trimethylalkylammonium chloride, dimethyldialkylammonium chloride, monoalkylamide acetate, or alkylmethyldipolyoxyethyleneammonium chloride, wherein alkyl is preferably C₂₋₆, for example, octyl group, dodecyl group, tetradecyl group, hexadecyle group, benzyl dimethyl lauryl ammonium chloride.

The aforesaid nonionic surfactant comprises: alkylphenylpolyoxyethylene, alkylpolyoxyethylene, alkylpolyoxyalkylene polyoxyethylene, fatty acid ester, alkylamine polyoxyethylene, alkylamidepolyoxyethylene, alkylaminepoly(oxyethyleneoxypropylene), and alkylamineoxide.

More specifically, the aforesaid alkylphenylpolyoxyethylene is preferably nonylphenyl polyoxyethylene, or octylphenyl polyoxyethylene. The aforesaid alkylpolyoxyethylene, more specifically, is preferably alkyl of C₄₋₂₆ saturated aliphatic group, for example, octyl, dodecyl, tetradecyl, hexadecyl, octadecyl, behenyl, or secondary alkyl group. The aforesaid alkylpolyoxyalkylene polyoxyethylene, more specifically, is preferably alkypolyoxypropylene polyoxyethylene or alkylpolyoxybutylene polyoxyethylene, and more preferably alkyl of C₄₋₂₆ saturated aliphatic group, for example, octyl, dodecyl, tetradecyl, hexadecyl, octadecyl, behenyl, or secondary alkyl group.

The aforesaid auxiliary surfactant comprises hydrophobe such as, but not limited to, hexadecane; polymer (low molecular weight) such as, but not limited to, polyester; alkyl alcohol such as, but not limited to, amyl alcohol, hexyl alcohol, butyl alcohol, 2-ethyl hexanol, or diacetone alcohol; alkyl mercaptan; comonomers or oil soluble initiator such as, but not limited to, benzoyl peroxide or AIBN. The aforesaid auxiliary surfactant may be used alone or by mixing two or more different types of auxiliary surfactant.

The aforesaid water is double deionized (DDI) water.

The aforesaid chain transfer agent comprises, but not limited to, dodecyl mercaptan.

The aforesaid solubilizing agent comprises methanol, isopropanol, ethyl acetate, butyl acetate, acetone, butanone, ethylene glycol, hexylene glycol, propylene glycol, dipropyleneglycol monobutylether, hexylene glycol, or dipropylene gylcol.

The aforesaid initiator comprises ammonium persulfate, sodium persulfate, 2,2′azobis-(2-amidinopropane)dihydrochloride, azobisisobutylnitrile (AIBN), or benzoyl peroxide.

The aforesaid buffering agent comprises acetic acid, phosphoric acid, malic acid, citric acid, and the sodium salt or potassium salt of the aforesaid substances.

The process for producing nano fluorine water- and oil-repellent of the present invention comprises microemulsion polymerization and miniemulsion polymerization, and the reaction could be carried out by means of batch polymerization, semi-continuous polymerization or core-shell polymerization. The process is divided into two stages, including the pre-emulsion stage and emulsion polymerization stage.

The following examples are used to further illustrate the preparation of the nano fluorinated water- and oil-repellent of the present invention and applications thereof, but the descriptions made in the examples should not be construed as a limitation on the actual application of the present invention.

Preparation of Nano Fluorinated Water- and Oil-Repellent of the Invention

Batch Polymerization:

(1) Pre-Emulsion Stage:

Mix the major components as described above, including perfluoroalkyl ethyl(meth)acrylate monomer or perfluoropolyether ethyl acrylate monomer, non-fluorinated (meth)acrylate, other special monomers, surfactant, auxiliary surfactant, DDI water, chain transfer agent, solubilizing agent, and buffering agent. If necessary, heat the mixture to 30° C.˜50° C. to ensure the uniform mixture of the aforesaid substances. The resulting mixture is then homogenized through a homogenizer at least twice under working pressure of 100˜500 bar, and a stable pre-emulsion mixture is obtained.

(2) Emulsion Polymerization Stage:

Place the aforesaid pre-emulsion mixture into a proper reactor equipped with an agitating device and an externally attached heating and cooling device, and a thermometer. First, purge the reactor with nitrogen for 30 minutes to replace air and the reactor temperature raised to 40° C.˜90° C., then add initiator and let the reaction continue for 4˜24 hours to obtain the nanometer-grade fluorine-based water- and oil-repellent of the present invention.

Semi-Continuous Polymerization:

(1) Pre-Emulsion Stage:

Obtain a stable pre-emulsion mixture employing the same steps and reaction conditions as those described in batch polymerization reaction.

(2) Emulsion Polymerization Stage:

Place part of the aforesaid pre-emulsion mixture into a proper reactor equipped ith an agitating device and an externally attached heating and cooling device and a mercury thermometer. First, purge the reactor with nitrogen for 30 minutes to replace air and the reactor temperature raised to 40° C.˜90° C., then add initiator. After maintaining the reactor temperature for 30 minutes, drop in the remaining pre-emulsion over a period of 4˜8 hours. After the addition of pre-emulsion liquid is completed, maintain the reactor temperature for 4-8 hours to obtain the aqueous dispersant of nano fluorinated water- and oil-repellent of the present invention.

Core-Shell Polymerization:

(1) Pre-Emulsion Stage:

Obtain a stable pre-emulsion mixture by mixing all the components, except non-fluorinated (meth)acrylate, and employing the same steps and reaction conditions as those described in the batch polymerization.

(2) Emulsion Polymerization Stage:

Place the non-fluorinated (meth)acrylate, other special monomers, surfactant, and DDI water into a proper reactor equipped with an agitating device and an externally attached heating and cooling device and a thermometer. First, purge the reactor with nitrogen for 30 minutes to replace air and the reactor temperature raised to 40° C.˜90° C., then add initiator and let the reaction continue for 0.5˜4 hours. Maintain the reaction temperature at 40° C.˜90° C. Add the pre-emulsion mixture and initiator into the reactor and let the reaction continue for 2-6 hours. The resulting product is an aqueous dispersant of nano fluorinated-water- and oil-repellent.

The raw materials required for making the aforesaid nano fluorinated water- and oil-repellent are in total 100% by weight, containing 1.5˜15 wt % perfluoroalkyl ethyl(meth)acrylate monomer or perfluoropolyetherethyl acrylate monomer, preferably 5˜12 wt %; 1.5˜15 wt % non-fluorinated (meth)acrylate, preferably 5˜12 wt %; 0.5˜5 wt % other acrylic monomers, preferably 0.8˜3 wt %; 0.2˜3 wt % surfactant, preferably 0.5˜1.5 wt %; 0.05˜1.5 wt % auxiliary surfactant, preferably 0.2˜0.8 wt %; 60˜90 wt % deionized water, preferably 65˜80 wt %; 0.05˜0.5 wt % chain transfer agent, preferably 0.08˜0.2 wt %; 0.5˜15 wt % solubilizing agent, preferably 1˜5 Wt %; 0.05˜0.5 wt % initiator, preferably 0.08˜0.2 wt %; and 0.02˜0.1 wt % buffering agent, preferably 0.04˜0.08 wt %.

The range of reaction temperature for producing the aforesaid nano fluorinated water- and oil-repellent is between 40° C. to 90° C., preferably between 55° C.˜75° C.; the reaction time is between 4 to 24 hours, preferably between 6˜16 hours.

The water- and oil-repellent of the present invention may be used to treat textile fabric, leather goods and paper products to render them with water and oil repellency. Conventional techniques may be employed in the application. For example, after applying the nano fluorinated water- and oil-repellent to the polyester fabric by padding or spraying, then dry the treated-substrate by air-drying or heat-curing that the water- and oil-repellency characteristics of the substrate could be developed. The time required to complete air-drying or heat-curing of the treated substrate will vary, depending on a number of factors, such as the composition or weight of the substrate, or the amount of residual liquid thereon.

Applications of Nano Fluorinated Water- and Oil-Repellent

(1) Treatment of Fabric

Dilute the aqueous dispersant of nanometer-grade fluorine-based water-oil repellent to an emulsion containing 0.5˜2% solid polymer by weight. Apply it to the selected fabrics, such as nylon tafeeta, polyester fiber or cotton fabric by padding, and then heat fabrics at 150° C. for 30 seconds.

(2) Water Repellency Test

Use AATCC Standard Test Method No.22 to test the water repellency of treated fabric specimen (see Table 1)

TABLE 1

| Water Repellency | |
|---|---|
| Rating Number | Condition |
| 100 | No wetting on surface |
| 90 | Slight wetting on surface |
| 80 | Partial wetting on surface |
| 70 | Wetting on surface |
| 50 | Wetting on entire surface |
| 0 | Complete Wetting on entire fabric |
| | inside out |

In the test, 250 ml of water is poured in trickles at 27 degree angle onto the fabric specimen stretched and secured on a plastic loop 6-inch in diameter. The water is trickled down onto the fabric from a 6-inch diameter plastic hoop. The water was discharged from a funnel suspended six inches above the fabric sample. After removing excess water, evaluate the specimen visually according to the published reference standards.

(3) Oil Repellency Test

Use AATCC Standard Test Method No.118 to test the oil repellency of treated fabric specimen (see Table 2)

TABLE 2

| Oil repellency Rating | |
|---|---|
| Number | Test Liquid |
| 8 | n-Heptane |
| 7 | n-Octane |
| 6 | n-Decane |
| 5 | n-Dodecane |
| 4 | n-Tetradecane |
| 3 | n-Hexadecane |
| 2 | n-Hexadecane 35%/Nujol 65% |
| 1 | Nujol |
| 0 | Less than 1 |

In the test, a series of organic liquids described above are applied dropwise to the fabric samples. Beginning with the lowest numbered test liquid, one drop (about 5 mm in diameter or 0.05 mL volume) was placed on each three locations at least 5 mm apart. Observe the liquid drop for 30 seconds. If, at the end of this period, two of the three drops were still spherical to hemispherical in shape with no wicking around the drops, observe the next highest numbered test liquid by the same test standard. Continue the test until one of the test liquid results in two of the three drops failing to remain spherical or hemispherical shape or wetting occurs. The oil repellency rating of the fabric is the highest numbered test liquid for which two of the three drops remain spherical to hemispherical, with no wicking for 30 seconds.

(4) Discoloration Test

X-Rite 948 is used to measure the total color difference (AE) of fabric specimen before and after the treatment of water- and oil-repellent.

### EXAMPLE 1

### Preparation of Nano Fluorine Water- and Oil-Repellent (I) of the Present Invention by Batch Polymerization

(1) Pre-Emulsion Stage:

Mix the following components to prepare pre-emulsion:
45 g of FA
22 g of CHMA
5 g of GMA
3 g of TMCAC
22.5 g of DPM
0.6 g of TDM
0.15 g of phosphoric acid
0.05 g of sodium hydroxide
401.1 g of DDI water

Place the mixture in a proper vessel. Agitate and heat to 35° C. and maintain the temperature for 30 minutes. Homogenize the resulting mixture through a homogenizer twice under working pressure of 200˜250 bar to obtain a stable pre-emulsion mixture.

(2) Emulsion Polymerization Stage:

Place the aforesaid pre-emulsion mixture into a 1L glass reactor equipped with an agitator, a thermometer, and a condenser. Purge the reactor with nitrogen gas for 30 minutes. Heat the reactor to 70° C. Add 0.6 gram of V-50 into the pre-emulsion to initiate the polymerization reaction and let the reaction continue for 10 hours under 70° C. The resulting polymer emulsion weighed 498.8 gram with solid content of 15.1%, and particle size of the emulsion averaged 65 nm as measured by Zetasizer 3000HS (2 nm 3000 nm).

### EXAMPLE 2

### Preparation of Nano Fluorinated Water- and Oil-Repellent (II) of the Present Invention by Batch Polymerization

(1) Pre-Emulsion Stage:

Mix the following components to prepare pre-emulsion:
45 g of FA
17 g of CHMA
5 g of SA (stearyl acrylate)
2 g of 2-HEMA (2-hydroxyethylmethacrylate)
3 g of GMA
2.5 g of TMCAC
0.6 g of C₁₃H₂₇O-(EO)₅—H
22.5 g of DPM
0.6 g of TDM
0.15 g of phosphoric acid
0.05 g of sodium hydroxide
401.1 g of DDI water

Place the mixture in a proper vessel. Agitate and heat to 35° C. and maintain the temperature for 30 minutes. Homogenize the resulting mixture through a homogenizer twice under working pressure of 200˜250 bar to obtain a stable pre-emulsion mixture.

(2) Emulsion Polymerization Stage:

Place the aforesaid pre-emulsion mixture into a 1L glass reactor equipped with an agitator, a thermometer, and a condenser. Purge the reactor with nitrogen gas for 30 minutes. Heat the reactor to 70° C. Add 0.6 gram of V-50 into the pre-emulsion to initiate the polymerization reaction and let the reaction continue for 10 hours under 70° C. The resulting polymer emulsion weighed 498.6 gram with solid content of 14.9%, and particle size of the emulsion measured with Zetasizer 3000HS (2 nm 3000 nm) averaged 65 nm.

### EXAMPLE 3

### Preparation of Nano Fluorinated Water- and Oil-Repellent (III) of the Present Invention by Batch Polymerization

In this example, the same raw materials, weights and polymerization method as those presented in Example 2 were employed, only the reaction temperature and reaction time were changed to 80° C. and 7 hours respectively. The resulting polymer emulsion weighed 498.1 gram with solid content of 14.7%, and the particle size of the emulsion measured with Zetasizer 3000HS (2 nm ˜3000 nm) averaged 53 nm.

### EXAMPLE 4

### Preparation of Nano Fluorinated Water- and Oil-Repellent (IV) of the Present Invention by Batch Polymerization

In this example, the same raw materials, weights and polymerization method as those presented in Example 2 were employed, only component TMCAC was changed to DMBLAC (dimethyl benzyl lauryl ammonium chloride), and reaction temperature and reaction time were changed to 80° C. and 7 hours respectively. The resulting polymer emulsion weighed 498.1 gram with solid content of 14.6%, and the particle size of the emulsion measured with Zetasizer 3000HS (2 nm 3000 nm) averaged 68 nm.

### EXAMPLE 5

### Preparation of Nanometer-Fluorinated Water- and Oil-Repellent (V) of the Present Invention by Semi-Continuous Polymerization

(1) Pre-Emulsion Stage:

Mix the following components to prepare pre-emulsion:
25 g of FA
30 g of CHMA
12 g of SA
4.5 g of 3-chloro-2-hydroxy-propyl methacrylate
2.1 g of TMCAC
1.0 g of C₁₃H₂₇O-(EO)₅—H
22.5 g of DPM
0.6 g of TDM
0.15 g of phosphoric acid
0.05 g of sodium hydroxide
401.1 g of DDI water

Place the mixture in a proper vessel. Agitate and heat to 35° C. and maintain the temperature for 30 minutes. Homogenizing the resulting mixture through a homogenizer under working pressure of 200˜250 bar at least twice to obtain a stable pre-emulsion mixture.

(2) Emulsion Polymerization Stage:

Weigh 50 gram of aforesaid pre-emulsion mixture and place it into a 1L glass reactor equipped with an agitator, a thermometer and a condenser. Purge the reactor with nitrogen gas for 30 minutes. Heat the reactor to 80° C. Add 0.6 gram of V-50 into the pre-emulsion to initiate the polymerization reaction and let the reaction continue for 1 hours under 80° C. Drop in the remaining pre-emulsion at an even speed over a period of 5 hours, and then maintain the temperature for 4 hours. The resulting polymer emulsion weighed 499.2 gram with solid content of 15.2%, and particle size of the emulsion measured with Zetasizer 3000HS (2 nm ˜3000 nm) averaged 60 nm.

### EXAMPLE 6

### Preparation of Nano Fluorinated Water- and Oil-Repellent (VI) of the Present Invention by Semi-Continuous Polymerization

(1) Pre-Emulsion Stage:

Mix the following components to prepare pre-emulsion:
45 g of FA
22 g of CHMA
2.2 g of 3-chloro-2-hydroxy-propyl methacrylate
2.8 g of 2-HEMA
2.1 g of TMCAC
1.0 g of C₁₃H₂₇O-(EO)₅—H
22.5 g of DPM
0.6 g of TDM
0.15 g of phosphoric acid
0.05 g of sodium hydroxide
401.1 g of DDI water

Place the mixture in a proper vessel. Agitate and heat to 35° C. and maintain the temperature for 30 minutes. Homogenize the resulting mixture through a homogenizer twice under working pressure of 200˜250 bar to obtain a stable pre-emulsion mixture.

(2) Emulsion Polymerization Stage:

Weigh 50 gram of aforesaid pre-emulsion mixture and place it into a 1L glass reactor equipped with an agitator, a thermometer, and a condenser. Purge the reactor with nitrogen gas for 30 minutes. Heat the reactor to 80° C. Add 0.6 gram of V-50 into the pre-emulsion to initiate the polymerization reaction and let the reaction continue for 1 hours under 80° C. Drip in the remaining pre-emulsion at an even speed over a period of 5 hours, and then maintain the temperature for 4 hours. The resulting polymer emulsion weighed 498.2 gram with solid content of 15.1%, and particle size of the emulsion measured with Zetasizer 3000HS (2 nm 3000 nm) averaged 58 nm.

### EXAMPLE 7

### Preparation of Nano Fluorinated Water- and Oil-Repellent (VII) of the Present Invention by Core-Shell Polymerization

(1) Pre-Emulsion Stage:

Mix the following components below to prepare pre-emulsion:
30 g of FA
15 g of CHMA
2.8 g of 2-HEMA
1.3 g of TMCAC
0.7 g of C₁₃H₂₇O-(EO)₅—H
22.5 g of DPM
0.6 g of TDM
0.15 g of phosphoric acid
0.05 g of sodium hydroxide
301 g of DDI water

Place the mixture in a proper vessel. Agitate and heat to 35° C. and maintain the temperature for 30 minutes. Homogenize the resulting mixture through a homogenizer twice under working pressure of 200˜250 bar to obtain a stable pre-emulsion mixture.

(2) Emulsion Polymerization Stage:

Weigh 22 gram of CHMA, 0.8 gram of TMCAC, 0.3 gram of C₁₃H₂₇O-(EO)₅—H, and 100 gram of DDI water, and place them into a 1L glass reactor equipped with an agitator, externally attached heating and cooling device, and a mercury thermometer. Purge the reactor with nitrogen gas for 30 minutes to replace air in the reactor with nitrogen. Add 0.1 gram of V-50 to initiate the polymerization reaction. Raise the reactor temperature to 80° C. and let the reaction continue for 1 hours. Then add the pre-emulsion mixture and 0.5 gram of V-50 into the reactor and keep the reaction temperature at 80° C. Let the reaction continue for 6 hours. The resulting polymer emulsion weighed 499.2 gram with solid content of 15.1%, and particle size of the emulsion measured with Zetasizer 3000HS (2 nm ˜300 nm) averaged 52 nm.

### EXAMPLE 8

### Preparation of Nano Fluorinated Water- and Oil-Repellent (VIII) of the Present Invention by Core-Shell Polymerization

In this example, the same raw materials, weights and polymerization method as those presented in Example 7 were employed, only component CHMA was changed to styrene. The resulting polymer emulsion weighed 499.1 gram with solid content of 14.9%, and the particle size of the emulsion measured with Zetasizer 3000HS (2 nm ˜3000 nm) averaged 55 nm.

### EXAMPLE 9

### Evaluation of Water Repellency and Oil Repellency of Nano Fluorinated Water- and Oil-Repellent

The nano fluorinated water- and oil-repellents prepared in Examples 1˜8 above were diluted with water into treatment fluid having solid content of 0.5 wt %. The polyester fabric was padded in said treatment fluid, squeezed by roller to 60% pick-up, and then dried at 120° C. for 2 minutes. The resulting polyester fabric specimen obtained was evaluated for water repellency and oil repellency. The results are depicted in Table 3 below.

### Comparative Example 1

Fluorinated water- and oil-repellent A bought on the market was diluted with water into treatment fluid having solid content of 0.5 wt %. The polyester fabric was padded in said treatment fluid, squeezed by roller to 60% pick-up, and then dried at 120° C. for 2 minutes. The resulting polyester fabric specimen obtained was evaluated for water repellency and oil repellency. The results are depicted in Table 3 below.

TABLE 3

| | Water | | |
|---|---|---|---|
| Nano fluorine water- | repellency | Oil repellency | Discoloration |
| and oil- repellent | (Rating No.) | (Rating No.) | (ΔE) |
| Example 1 | 100 | 5 | 0.41 |
| Example 2 | 100 | 6 | 0.42 |
| Example 3 | 100 | 6 | 0.37 |
| Example 4 | 100 | 6 | 0.29 |
| Example 5 | 100 | 5 | 0.47 |
| Example 6 | 100 | 6 | 0.39 |
| Example 7 | 100 | 5 | 0.32 |
| Example 8 | 100 | 6 | 0.41 |
| Comparative Example 1 | 90 | 4 | 1.02 |

### EXAMPLE 10

### Evaluation of Water Repellency and Oil Repellency of Nano Fluorinated Water- and Oil-Repellent

The nano fluorinated water- and oil-repellents prepared in Examples 1˜8 above were diluted with water into treatment fluid having solid content of 0.5 wt %. The polyester fabric was padded in said treatment fluid, squeezed by rollern to 60% pick-up, and then dried at 170° C. for 1.5 minutes. The resulting polyester fabric specimen obtained was evaluated for water repellency and oil repellency. The results are depicted in Table 4 below.

### COMPARATIVE EXAMPLE 2

Fluorinated water- and oil-repellent A bought in the market was diluted with water into treatment fluid having solid content of 0.5 wt %. The polyester fabric was padded in said treatment fluid, squeezed by roller to 60% pick-up, and then dried at 170° C. for 2 minutes. The resulting polyester fabric specimen obtained was evaluated for water repellency and oil repellency. The results are depicted in Table 4 below.

TABLE 4

| | Water | | |
|---|---|---|---|
| Nanometer fluorine water- | repellency | Oil repellency | Discoloration |
| and oil- repellent | (Rating) | (Rating) | (ΔE) |
| Example 1 | 100 | 5 | 0.72 |
| Example 2 | 100 | 6 | 0.89 |
| Example 3 | 100 | 6 | 0.85 |
| Example 4 | 100 | 6 | 0.91 |
| Example 5 | 100 | 6 | 0.69 |
| Example 6 | 100 | 5 | 0.76 |
| Example 7 | 100 | 6 | 0.82 |
| Example 8 | 100 | 6 | 0.86 |
| Comparative Example 2 | 100 | 5 | 1.38 |

Based on the test results above, the nano fluorinated oil-water repellent of the present invention, in comparison with water- and oil-repellents currently available on the market, exhibits better water and oil repellency when applied to textile fabrics and produces optimum effect on the discoloration of the textile.

Note: The full names or chemical formulas of the aforementioned chemicals are as follows:
FA: (CF₃CF₂(CF₂CF₂)ₙCH₂CH₂OCOH═CH₂ (n=3, 4, 5, 6 for compounds with weight ratio of 61:28:9:2 respectively))
CHMA: Cyclohexyl methacrylate
GMA: Glycidyl methacrylate
TMCAC: Trimethyl coco ammonium chloride
DPM: Dipropyleneglycol monobutylether
TDM: t-Dodecyl mercaptan
SA: stearyl acrylate
2-HEMA: 2-hydroxyethylmethacrylate
V-50: 2,2′Azobis-(2-amidinopropane)dihydrochloride

The nano fluorinated water- and oil-repellent of the present invention has been disclosed in the examples. However the examples should not be construed as a limitation on the actual applicable scope of the invention, and as such, all modifications and alterations without departing from the spirits of the invention and appended claims shall remain within the protected scope and claims of the invention.

1. A fluorinated water- and oil-repellent in the form of aqueous dispersant, comprising fluorinated acrylic and other acrylic monomers, characterized in that the average particle size of the emulsion is less than 100 nm.

2. A fluorinated water- and oil-repellent having a composition comprising:
fluorinated acrylic and other acrylic monomers is presenting in an amount of 5˜35% of the entire composition by weight;
surfactant is presenting in an amount of 0.2˜3% of the entire composition by weight;
auxiliary surfactant is presenting in an amount of 0.05˜1.5% of the entire composition by weight;
water is presenting in an amount of 60˜90% of the entire composition by weight;
chain transfer agent is presenting in an amount of 0.05˜0.5% of the entire composition by weight;
solubilizing agent is presenting in an amount of 0.5˜15% of the entire composition by weight;
initiator is presenting in an amount of 0.05˜0.5% of the entire composition by weight; and
buffering agent, present in an amount of 0.02˜0.1% of the entire composition by weight;
wherein the average particle size of the emulsion of said fluorine-based water- and oil-repellent is less than 100 nm.

3. The fluorinated water- and oil-repellent according to claim 2, wherein said fluorinated acrylic and other acrylic monomers comprise:
perfluoroalkylethyl (meth)acrylate monomer or perfluoropolyetherethyl acrylate monomer, present in an amount of 1.5 ˜ 15% of the entire composition by weight;
nonfluorinated (meth) acrylate, present in an amount of 1.5˜15% of the entire composition by weight; or
other special monomers, present in an amount of 0.5˜5% of the entire composition by weight.

4. The fluorinated water- and oil-repellent according to claim 3, wherein said perfluoroalkylethyl (meth)acrylate monomer or perfluoropolyether ethyl acrylate monomer having the following formula: 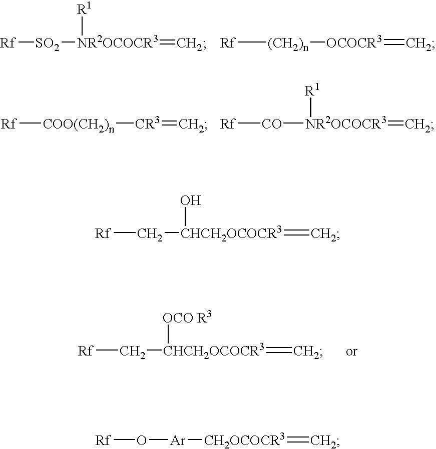
wherein Rf is C₃₋₂₁ polyfluoroalkyl, polyfluoro alkyl or perfluoropolyether having average molecular weight of 500˜5000, R¹ is hydrogen or C₁₋₁₀ alkyl, R² is C₁₋₁₀ alkylene, R³ is hydrogen or methyl, Ar is substituent-containing phenyl, and n is an integer from 1 to 10.

5. The fluorinated water- and oil-repellent according to claim 3, wherein said nonfluorinated (meth) acrylate comprises alkyl (meth) acrylate containing C₂₋₂₂ straight or branched chain alkyl group.

6. The fluorinated water- and oil-repellent according to claim 5, wherein said nonfluorinated (meth) acrylate comprises alkyl (meth) acrylate containing C₆₋₁₈ straight or branched chain alkyl group.

7. The fluorinated water- and oil-repellent according to claim 3, wherein said other special monomers comprise: N-methylol monomer, hydroxyalkyl (meth)acrylate monomer, alkoxy(meth)acrylate monomer, vinyl chloride, vinyl halide, styrene, glycidyl methacrylate, or 3-chloro-2-hydroxy-propyl methacrylate.

8. The fluorinated water- and oil-repellent according to claim 7, wherein said N-methylol monomer could be N-methyloacrylamide or N-methylomethacrylamide.

9. The fluorinated water- and oil-repellent according to claim 7, wherein said hydroxyalkyl (meth)acrylate monomer is hydroxyalkyl (meth)acrylate having C₂₋₄ alkyl chain, such as 2-hydroxyethyl acrylate or 2-hydroxyethyl methacrylate.

10. The fluorinated water- and oil-repellent according to claim 7, wherein said alkoxy(meth)acrylate monomer is alkoxy(meth)acrylate having C₂₋₄ alkyl chain and has 1 to 12 oxyalkylene units in each molecule.

11. The fluorinated water- and oil-repellent according to claim 10, wherein said alkoxy(meth)acrylate monomer contains C₂₋₄ alkyl chain and has 4 to 10 oxyalkylene units per molecule.

12. The fluorinated water- and oil-repellent according to claim 2, wherein said surfactant comprises cationic surfactant and nonionic surfactant.

13. The fluorinated water- and oil-repellent according to claim 12, wherein said cationic surfactant comprises amine salt, quaternary ammonium salt, or oxyethylene-addition type ammonium hydrochloride.

14. The fluorinated water- and oil-repellent according to claim 12, wherein said nonionic surfactant comprises alkylphenylpolyoxyethylene, alkylpolyoxyethylene, alkylpolyoxyalkylenepolyoxyethylene, fatty acid ester, alkylaminepolyoxyethylene, alkylamidepolyoxyethylene, alkylaminepoly (oxyethyleneoxypropylene), or alkylamineoxide.

15. The fluorinated water- and oil-repellent according to claim 2, wherein said auxiliary surfactant comprises hydrophobe, low molecular weight polymer, alkyl alcohol, alkyl mercaptan, comonomers, or oil soluble initiator.

16. The fluorinated water- and oil-repellent according to claim 2, wherein said solubilizing agent comprises methanol, isopropanol, ethyl acetate, butyl acetate, acetone, butanone, ethylene glycol, hexylene glycol, propylene glycol, dipropyleneglycol monobutylether, hexylene glycol, or dipropylene gylcol.

17. The fluorinated water- and oil-repellent according to claim 2, wherein said initiator comprises ammonium persulfate, sodium persulfate, 2,2′azobis-(2-amidinopropane)dihydrochloride, azobisisobutylnitrile, or benzoyl peroxide.

18. The fluorinated water- and oil-repellent according to claim 2, wherein said buffering agent comprises acetic acid, phosphoric acid, malic acid, citric acid, or the sodium salt or potassium salt thereof.

19. A process for producing fluorinated water- and oil-repellent, comprising the steps of:
(a). mixing the components well;
(b). homogenizing the mixture obtained in step (a). through a homogenizer under working pressure of 100˜500 bar at least twice to obtain a pre-emulsion mixture; and
(c). subjecting the pre-emulsion mixture obtained in step (b). to emulsion polymerization under reaction temperature of 40˜90° C. and reaction time of 4˜24 hours.

20. The process for producing fluorinated water- and oil-repellent according to claim 19, wherein the polymerization reaction used in the process comprises microemulsion polymerization or miniemulsion polymerization.

21. The process for producing fluorinated water- and oil-repellent according to claim 20, wherein said polymerization reaction may be carried out by means of batch polymerization, semi-continuous polymerization, or core-shell polymerization.

22. The process for producing fluorinated water- and oil-repellent according to claim 19, wherein said step (b). may further comprise a heating procedure to render the components mixed evenly.

23. The process for producing fluorinated water- and oil-repellent according to claim 22, wherein the temperature of said heating procedure ranges between 30° C. and 50° C.

24. The fluorinated water- and oil-repellent according to claim 3, wherein said fluorinated acrylic and other acrylic monomers comprise:
perfluoroalkylethyl (meth)acrylate monomer or perfluoropolyether ethyl acrylate monomer, present in an amount of 5˜12% of the entire composition by weight;
nonfluorinated (meth) acrylate, present in an amount of 5˜12% of the entire composition by weight; or
other special monomers, present in an amount of 0.8˜3% of the entire composition by weight.

25. The fluorinated water- and oil-repellent according to claim 2, wherein said surfactant is presenting in an amount of 0.5˜1.5% of the entire composition by weight;
surfactant is presenting in an amount of 0.5˜1.5% of the entire composition by weight;
auxiliary surfactant is presenting in an amount of 0.2˜0.8% of the entire composition by weight;
water is presenting in an amount of 65˜80% of the entire composition by weight;
chain transfer agent is presenting in an amount of 0.08˜0.2% of the entire composition by weight;
solubilizing agent is presenting in an amount of 1˜5% of the entire composition by weight;
initiator is presenting in an amount of 0.08˜0.2% of the entire composition by weight; and
buffering agent is presenting in an amount of 0.04˜0.08% of the entire composition by weight.
